(19) United States
(12) Patent Application Publication
(10) Pub. No.: US 2004/0260571 A1
(43) Pub. Date: Dec. 23, 2004

(54) System broker and locate high value property

(76) Inventor: Kenneth Gillespie, Freeport, NY (US)

Correspondence Address: National IP Rights Center, LLC, Suite 400, 550 Township Line Road, Blue Bell, PA, 19422, US

(21) Appl. No.: 10/780,541

(22) Filed: Feb. 17, 2004

Related U.S. Application Data
(60) Provisional application No. 60/447,626, filed on Feb. 15, 2003.

(51) Int. Cl. G06F 17/60

(52) U.S. Cl. 705/1

(57) ABSTRACT

An apparatus for managing the purchase and sale by a broker of a high value piece of property comprising: a control unit for inputting information by a broker related to a high value property item and for posting information about the property and publishing the information to at least one buyer.

This application claims the priority of U.S. Ser. No. 60/447,626 filed Feb. 15, 2003.

### FIELD OF THE INVENTION

The present invention relates to a method and system for selling high value property (HVP). In particular, present invention is directed to a method and apparatus for locating and tracking HVP, identifying HVP(s) that become available for sale and flagging them, locating the seller and suitable buyer(s) for each HVP, and communicating the necessary information to buyers and sellers so that suitable buyers may come forward.

### BACKGROUND OF THE INVENTION

Expensive (so-called “big ticket”) merchandise often have long life cycles, e.g., 10-30 years and sometimes much, much longer. These items, whether new or used often have substantial monetary value, and are almost always transportable. Such items include aircraft, cranes, derricks, demolition equipment, earth (and offshore) drilling & tunneling & pumping equipment, earth moving equipment, farm equipment & machinery, fork trucks, all types and sizes of vehicles. e.g., railway cars, locomotives, all types of vehicles e.g., busses, planes, van conversions, motor coaches and trucks—including tractors/trailers, automobiles, race cars, vessels and watercraft, residential trailers, misc. other machinery and vehicles, medical testing and other equipment of various types and sizes, main-frame computers, web servers, switches, routers, wireless transmitting equipment, professional video and audio equipment, robots, various and sundry collectibles, and more.

The “HV” (High Value) aspect defining HVPs is the fact that they are valuable to the extent that they are often sold (or brokered) by or through people who do not own them. These “non-owner intermediaries are usually paid commissions for bringing about the sales of HVPs. Dealers, brokers, and auctioneers are typical examples of these kinds of “non owner sellers”, and will be hereinafter referred to as “Dealers” or “Brokers”.

One who obtains actual ownership of HVPs (new or used) to resell it at a profit is often skilled in the art of selling HVPs and will also be referred to herein as a “Dealer, “Broker” or “Speculator”. Some HVPs are registered with governmental authorities (e.g.: watercraft, aircraft, & vehicles) and some are not. HVPs are frequently produced in an environment that is less “manufacturing” oriented and more “custom made” or oriented.

In fact, some HVPs are impossible to replicate exactly because their original producer may no longer be alive. Some of these types may include, but are not limited to antiques, art, jewelry, and musical instruments. Some items with little initial value become HVPs as a result of an event or person that became connected with their history (e.g., a piece of furniture that was owned by a famous individual or a pen that was used to sign a famous document).

The business of a broker of HVPs relies on his/her direct connection with the market and his or her supply of HVPs and the demand for them. Without HVPs and a pool of buyers, the business could not exist. The more HVPs a given broker has available, the more sales he or she can achieve. Often brokers expend much of their time locating HVPs that fall within their areas of expertise. They sometimes “have” buyers who clearly specify the type, style, age range, etc. of HVP(s) they are interested in purchasing.

The more time brokers spend looking for HVPs that are for sale, the more often they also “connect” with current owners of HVPs who are interested in purchasing more (or changing) their current HVP(s), (e.g., upgrading). A large part of the job and career of a broker, then, is spent making connections within his or her market. Each deal a broker makes requires a connection to both the “buy side” and the “sell side” of the market. Deals always begin with a connection to one of the two sides of the market. No deal can proceed unless suitable connections are made to both sides of the market.

Put plainly, a broker with an HVP to sell and no buyer has connected with the “sell side”. His/her risk is that if (s)he doesn't find a buyer and the seller becomes impatient, (s)he may lose the chance to sell the HVP. A broker with a buyer and no matching HVP must find a suitable HVP as quickly as possible. His/her risk is that if (s)he doesn't locate one, the buyer may find one elsewhere.

In terms of “connecting”, then, it would be best for a broker if the market would “come to” him or her. Unfortunately for brokers, this does not simply happen. Therefore, successful brokers often take action to make their connections to the market. For example, brokers often go to the physical sites where the type of HVPs they handle can be found. Sometimes they respond to ads for HVPs for sale published in advertising sections of various publications.

Going to the physical sites of HVPs often enables brokers to interact directly with the market by directly communicating with owners of HVPs. Calling sellers of HVPs who advertise them for sale also often enables effective communication with owners to occur. Owners often give details to about their HVPs to brokers. The process of detailed information giving is usually referred to as “getting a listing” and the information itself is often referred to as a “listing”. The process is hard, time-consuming and expensive.

Brokers sometimes acquire listings by chance and sometimes by their own methods. When a broker obtains a listing, (s)he has connected to the sell side of the market for the particular HVP that is “listed”. But for a broker who needs to earn a living, connecting to the sell side for just one HVP of a type is hardly sufficient. Brokers usually work to accumulate numerous listings. A “typical” broker might have 10-50 listings available at a given time. A broker should desire to “cover” the market by maximizing his/her ability to continually connect with HVPs and their owners continually. A broker's best advantage is knowing many HVPs and their owners even before a particular owner decides to sell (or change) his/her present HVPs (e.g., upgrading).

It would be desirable to provide a system by which brokers could easily identify HPVs and comprehensively list and sell such HPVs.

It is an object of the present invention to provide a system which facilitates the matching of HVP sellers with brokers to match buyers and sellers.

It is an object of the present invention to provide a system which provides brokers with the ability to download advertising by which brokers can access HPVs.

It is a further object of the present invention to provide a system by which brokers can download advertising and with which a broker can identify and get listings.

It is a further object of the present invention to provide a system in which brokers can upload listing advertisements

It is a further object of the present invention to provide a system in which a uniform listing form is provided for inputting information for listings.

These and other objects of the invention will become apparent from the summary and detailed description which follow.

### SUMMARY OF THE INVENTION

The invention provides broker/dealers of HVPs with a method and system comprising a “suite” of applications they can utilize to keep the markets they “work” moving. The invention provides the brokers for HVPs with a complete, efficient apparatus and method and a comprehensive suite of functions related to the location, listing and sales functions. The functions, in one embodiment, reside in a desktop tool which will reside on the computer system of a broker.

The invention provides methods to locate an HVP, and to locate ready, willing and able buyers and sellers who are interested in exchanging (buying and selling) specific HVP(s) which meet certain specifications. In another aspect, the invention can automatically match appropriate buyers and sellers who have provided specifications (matching buyers “Requests” to sellers “Listings”) of the HVP they wish to locate or sell and automatically communicate the information needed to buyers and sellers. The invention saves brokers substantial time and prevents brokers who work in “their” markets from overlooking prospective buyers and/or sellers unintentionally as a result of human error.

Thus, the invention provides brokers, buyers and sellers of HVPs with the ability to more efficiently and quickly accomplish their respective desired results than the myriad of different methods that convolutes the current marketplace. The invention enables each broker to maintain his data on his own computer or network. The operation of the buyer vs. HPV matching function, for example, is performed at the broker's own location with the search results being disclosed solely to the broker if he wishes, prior to transmitting information to the client(s). The broker may automatically transmit information to the “matched” clients at his discretion based on the client's preference and/or the broker's judgment of what method is best under a given set of circumstances.

A critical feature of invention is the inclusion of a digital management system which may be web-based but will, in a preferred embodiment reside on the local computer of brokers. The system further includes a feature which facilitates the uniform collection of listing information.

The invention further includes a feature from downloading multiple print ads such that HPVs can quickly identified for the broker to list. In addition, the invention contemplates a system whereby a broker can maintain full control over a listing or share a listing on a multiple listing basis. The creation and use of a Uniform Listing Form greatly facilitates this process over currently known methods.

The invention guides users through the process, substituting computing power to quickly perform otherwise time consuming tasks that humans often currently perform, transmitting information (completely automatically if so ordered) that must be exchanged between the people, and as a result, accomplising the task of bringing suitable buyers and sellers together more efficiently, faster, and with more accurate information. Thus the invention creates strong potential benefits to buyers, sellers, in terms of succeeding in locating the HVPs best suited to them, and time saving economic benefits to buyers, sellers and dealers or brokers.

The invention thus comprises an apparatus having a suite of features for tracking HVPs, “flagging” them when they become for sale, identifying their owners, collecting thorough and accurate data in connection with the HVPs for sale in a uniform method, disseminating the uniform information and updates to the general market through numerous communications “channeling” methods, identifying buyers looking for HVP's with specific requirements, identifying the HVPs for sale that match the specific requirements of the buyers who have set forth such requirements, and transmitting the details of the matching HVP's to the buyers who have set forth specifications of the HVP(s) they seek to locate.

In accordance with the present invention, an apparatus for managing the purchase and sale by a broker of a high value piece of property comprising: a control unit for inputting information by a broker related to a high value property item and for posting information about the property; and publishing the information to at least one buyer.

In a further embodiment, the invention comprises an apparatus for managing the transaction between a broker and a seller of a high value property comprising: program means for identifying a plurality of high value property; a control unit for inputting listing information about at least one high value property to be sold and determining whether the high value property is to be placed for sale on or within a larger network of brokers; means for assisting the at least one seller in formulating an asking price for the at least one high value property; and means for publishing the listing to third parties at the asking price.

In still a further embodiment, the invention is a method for managing the relationship between a broker and a seller of a high value property comprising: identifying a plurality of high value property for sale and their sellers; inputting listing information about at least one high value property to be sold; determining whether the high value property is to be placed for sale on within a larger network of brokers; assisting the prospective seller in formulating an asking price for the high value property; and publishing the listing to at least one third party.

### BRIEF DESCRIPTION OF THE FIGURES

FIG. 1 a block diagram of system of the present invention.

FIG. 2 is a more specific diagram of an operating environment of the system of the present invention.

FIG. 3 is the database architecture of the present invention.

FIGS. 4 to 8 illustrate prospective user screens in accordance with the present invention.

FIGS. 9 to 14 illustrate operative examples of the present invention

### DETAILED DESCRIPTION OF THE INVENTION

The present invention is directed to a system to facilitate the connection of HVP to brokers, sellers and buyers. While the present invention is being described in the context of a system using a personal computer, the manner of the end user device is not critical to the present invention. The present invention may be used with any system that connects to the Internet or uses other IP transport methods. The end user device can comprise any end user device which can connect to a network such as a wireless device, palm pilot, PDA, end user work station or hand-held device.

In a most preferred embodiment, the present invention is directed to a system for facilitating the brokerage, sale, and purchase of HVPs, in one embodiment including a worldwide computer network. Over the past fifteen (15) years, personal computers have become relatively powerful and inexpensive and have gained widespread use in a significant number of homes and businesses. With a modem, personal computers can communicate with other computers through communication networks and access many resources on the so-called “Information Super Highway.” Companies such as America Online, CompuServe and Prodigy, which traditionally provided so-called “content” over proprietary networks, have begun to provide access by personal computer users to an expansive international network of computer networks known as the Internet.

As is well known by those skilled in the art, the World Wide Web is a graphical sub-network of the Internet. With common “Web Browser” software such as Mosaic, Netscape Navigator, or Microsoft Explorer, end users may easily access Internet information and services on the World Wide Web. A web browser handles the functions of locating and targeting information on the Internet and displaying the information provided by the Web Server. The World Wide Web utilizes technology called “Hyper-Text” to organize, search and present information on the Internet. Using a web browser, the end user can select a word (“Hyper-Text word”) from a view document and be linked to another document featuring information related to the word.

The present invention is broadly directed to a computer network for distributing information regarding the purchase, sale and brokerage of high value property such as boats, planes, etc. The present invention is designed, in one embodiment, to be utilized on the World Wide Web or Internet, although the present invention is equally applicable to other network environments. As noted above, the present invention is similarly related to user interfaces which are not computers such as palm pilots, wireless and cellular devices.

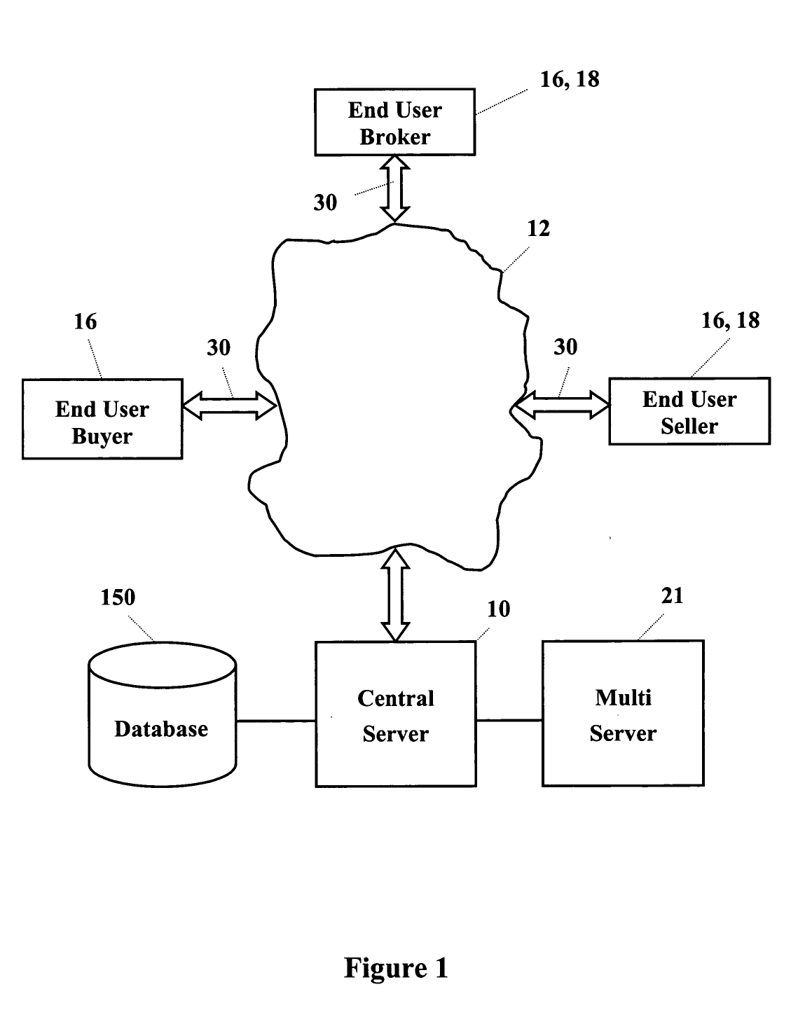

Referring to FIG. 1, a most preferred embodiment of the present invention is disclosed and shown. The most preferred embodiment comprises a central computer server 10 connected by a computer network 12 to remote end user stations 14. The central server connects to a database 150. As will be discussed herein, the database will include a large quantity of listed HVP items. It is to be noted that the central database will not store all HVPs and that many HVPs will be stored locally by brokers who do not desire to share listings and who access the system via a Broker Digital Management Suite to be described in greater detail herein. The system will facilitate the ability of brokers to share or forward selectively to any or all other brokers in the system.

In a preferred embodiment, end user stations 14 comprise a plurality of end users 16, 18. End users 16, 18 are defined herein as individuals linked to the system who comprise sellers, buyers and brokers of HVPs. Users 16, 18 are linked with the central computer server 10 via a transport medium 30. End users 16, 18 will typically comprise sellers, brokers and buyers who, in a most preferred embodiment, will be linked via a global computer network 12 such as the Internet or Worldwide web, but other embodiments including LANs, WANs and Intranets, fulfill the spirit and scope of the present invention.

The end user devices 16, 18 will typically comprise any device that connects to the system via the Internet or other IP transport methods and includes, but is not limited to, such devices as televisions, computers, hand-held devices, cellular phones, land based telephones, wireless electronic devices and any device which uses a transport medium 30. Non-limiting examples of a transport medium 30 applicable for use in the present invention comprise any backbone or link such as an ATM link, FDDI link, satellite link, cable, cellular, twisted pair, fiber optic, broadcast wireless network, the internet, the world wide web, local area network (LAN), wide area network (WAN), or any other kind of intranet environment such a standard Ethernet link. In such alternative cases, the clients will communicate with the system using protocols appropriate to the network to which that client is attached. All such embodiments and equivalents thereof are intended to be within the scope of the present invention.

Referring again to FIG. 1, the present invention may comprise a multi-server 21 environment which comprises a computer system in accordance with the present invention that allows the multiple end users 16, 18 to communicate with the system. Through communication link and transport medium 30, end user seller, buyers and brokers 16, 18 are linked to the central server 12, preferably by a customizable interface to be described in greater detail below.

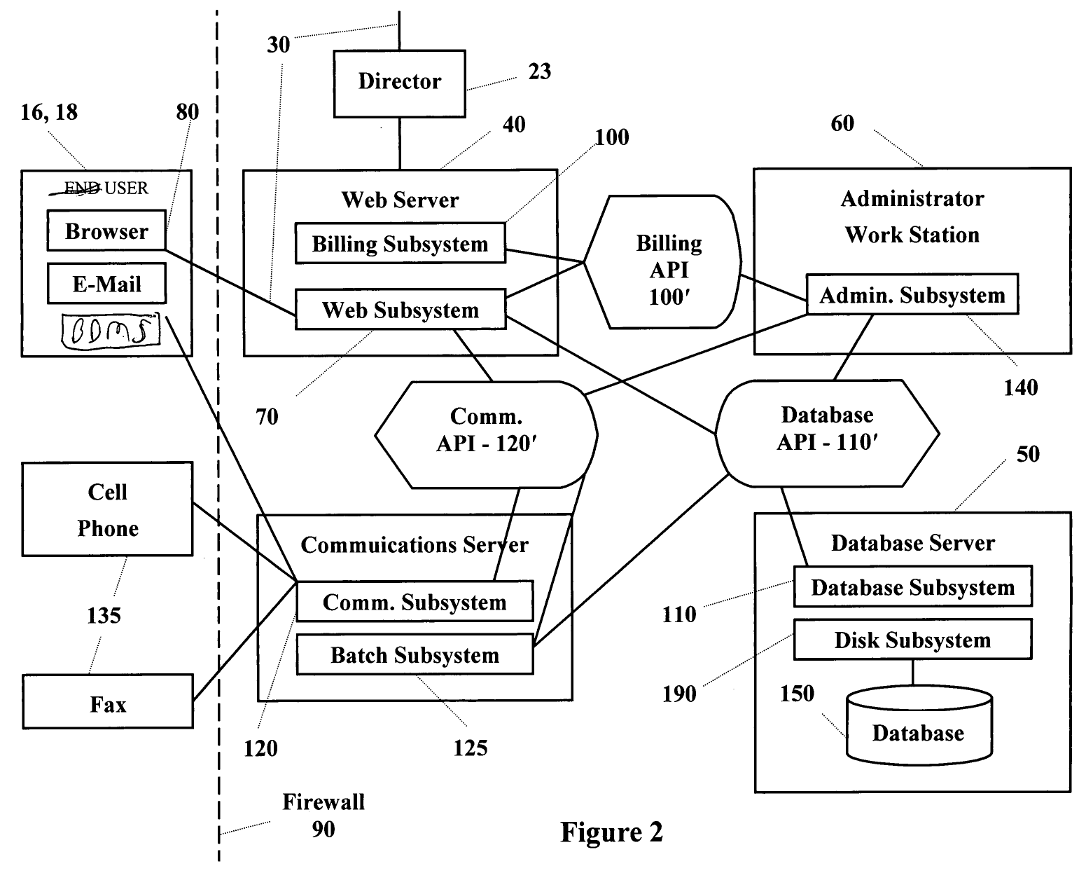

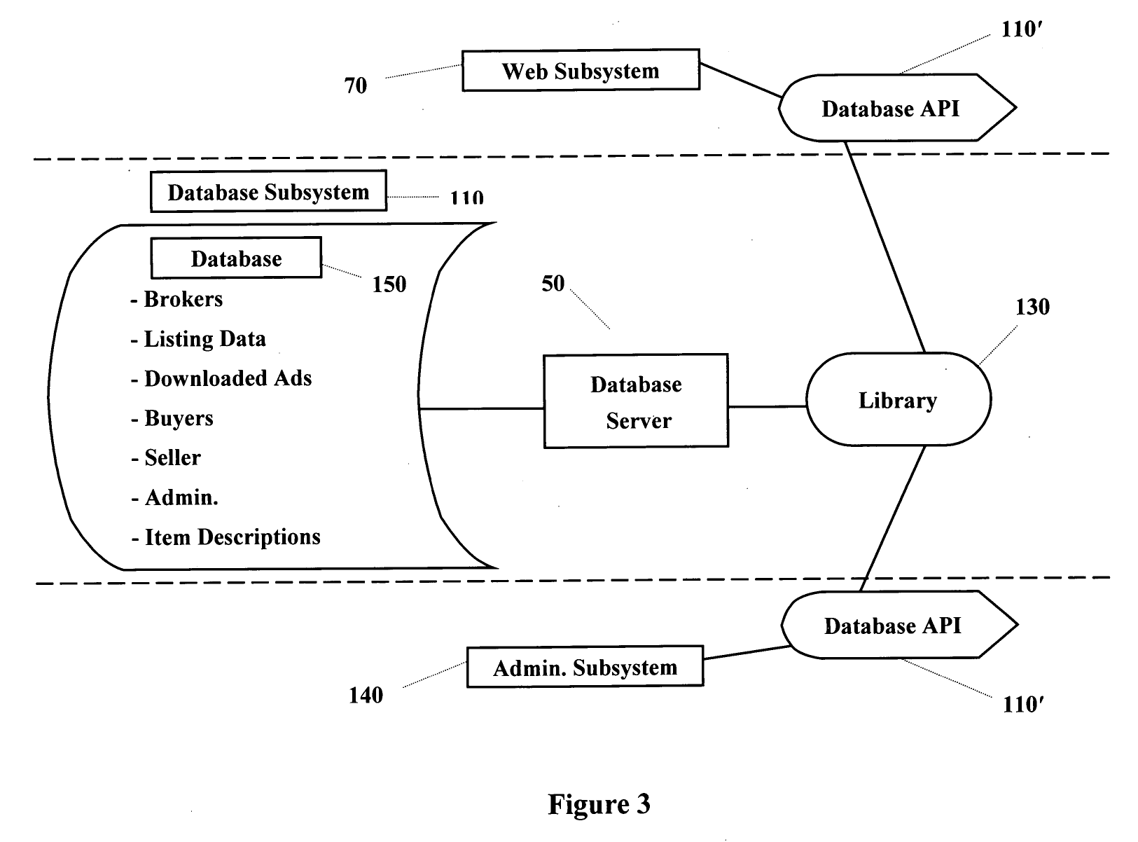

Referring to FIGS. 2 and 3, the central server and database systems of the present invention are now shown and described in greater detail. A local director 23 routes signals through the system to the various servers, to be described below, and to and through transport medium 30 to end users 16, 18. The system preferably includes two primary servers, a web server 40 and a database server 50 which may operate using such database platforms as SQL server or Oracle. The system may operate under other platforms such as ASP and JAVA (e.g. J2EE) Hence, in one embodiment the SQL server may run SQL server database management software from Microsoft Corporation. Alternatively, the server can further comprise an Oracle database server. The system further includes an administrative work station 60 or system which provides the administrative capabilities and monitoring for the system under the control of an administrative subsystem 140. The administrative work station 60 allows administrators or other operators to perform routine operations which affect the entire system. Such operations include, but are not limited to, administering the accounts of end users 16, 18 monitoring the traffic through the system, the tabulating of user balances and ratings, printing reports and maintaining the programs that comprise the overall system.

A web subsystem 70 is responsible for all interactions with a web browser 80 in the end user devices 16, 18 and serves as the end user interface to the system. All interactions between the end user devices 16, 18 and the database subsystem occur through the web subsystem 70. Internet Information Server 200 (IIS) by Microsoft Corporation is an exemplary web server software system 70 in accordance with the present invention, although the present invention is in no way limited to this system. The expression of the user interface presented to end users 16, 18 in their client devices may be implemented as HTML or other high level computer language or technology, and may be displayed in a standard web browser.

All world wide web systems listed above are preferably communicated, for example, by an Ethernet 100 base T network and a switching hub. In addition, a second isolated network segment will preferably exist between the web server 40 and the external communications hardware (e.g. internet router). Such a system will keep external traffic isolated from the internal network, as well as provide a dedicated connection between the web server 40 and the Internet for maximum throughput. The systems will have an initial configuration of random access memory for the web server 40 and preferably at least 128 megabits for the database server 50, both having the capability to expand.

The web server 40 may be a point of entry to the entire system. The system determines the identity of the user 16, 18 and makes appropriate decisions while serving web pages to the end user 16, 18. The web server 40 sends HTML, XML, JAVA, or other high level computer language to the end user work stations 16, 18, validates passwords, sends logging and transaction information to the database server 50, and performs logical operations, thus behaving as a transactional server.

As noted above, in one embodiment, the server operating system may be a Windows NT server, a multi-platform operating system provided by Microsoft Corporation. The Sun Microsystems Solaris is an alternative embodiment. The server typically includes IIS, which is a completely integrated Internet application platform. IIS includes a high-performance web server, an application development environment, integrated full-text searching, multi-media streaming and site management tools. The security infrastructure is integrated within the server, thus enabling an easy-to-maintain and highly-secure web development and deployment environment. It is to be appreciated that the invention envisions new and expanding technologies.

The operators of the central system may create, delete and update account information by utilizing the administrative subsystem 140 in administration work station 60. A billing subsystem 100 is used for crediting and debiting end user accounts.

Database 110, communication 120 and billing 100 subsystems thus execute essential services for the other parts of the system, and will therefore have well-defined application program interfaces (API) 110′, 120′, 100′, as is well recognized by those with skill in the art. The system will preferably be protected for the Internet by a “firewall” 90 which is a safety precaution, and important with respect to the present invention due to the sensitive and confidential nature of the information in the database. As will be discussed below, firewall 90 plays an important and critical role in the present invention because of the confidentiality of the data associated with some applications of the present invention.

In a preferred embodiment, the database subsystem 110 stores all pertinent information pertaining to user accounts, administrator accounts, payment and remuneration parameters, as well as general dynamic system information. All interactions with the database subsystem 110 are performed through a database API 110′ which may define the interface to a library of stored procedures 130. These are used to implement high-level database functions and to shield the details of the database implementation from the other subsystems. The database subsystem 110 is preferably implemented using database server 50.

The administration subsystem 140 provides an interface for operators and managers of the system to modify the database, print reports, view system data and log user comments and complaints. The administration subsystem 140 provides a collection of access forms, queries, reports and modules to implement the administration interface. Administrators typically will have the power within the system to force most actions. The administration subsystem 140 will interact with the communications, database and billing subsystems.

The communications subsystem 120 interfaced to a communications API 120′ will be used to email and contact end users 16, 18. End users 16, 18 may be notified by phone, fax, email or pager, or other communications devices which can be contacted by the system 135. End users 16, 18 will also have a password accessed section of a website where they can access information relevant to their activities and be provided with detailed reports.

A batch subsystem 125 may periodically send out grouped notifications. It will access the database subsystem 110 to determine what notifications are required, and uses the communication subsystem 120 to make those notifications. A group notification may comprise a special premium offered to end users 16, 18. The billing subsystem 100 will be used to verify and bill credit cards and communicate through the billing API 100′ to the administration subsystem 140, and potentially to an outside billing and verification service which could be used to perform the billing functions.

Referring to FIG. 3, the database server 50 which implements the database subsystem 110 of the present invention comprises a server that maintains all associated logging and transaction information for the system. Through the database 150 (which is backed up by a backup database for safety purposes), the database server 50 logs information regarding all brokers, public available listings, the HVPs being sold and maintains user account information, maintains account balances, produces and prints reports, hosts backup operations and performs statistical calculations for the entire system.

The database server 50 is preferably a dual processor computer microprocessor. Each connection to the database 150 and its associated work may be handled by a separate thread within the database server 50 process space. It is anticipated that a dual processor machine is sufficient for the type and amount of transactions that it will be performing, however if it proves insufficient, the database can be “striped” to two or more machines to distribute the server load.

In one embodiment, there will be one operator workstation 60 used for administering the central system. As the need for additional workstations arises, additional operator workstations can be added by adding additional computer systems, installing the administration software and connecting them to the LAN.

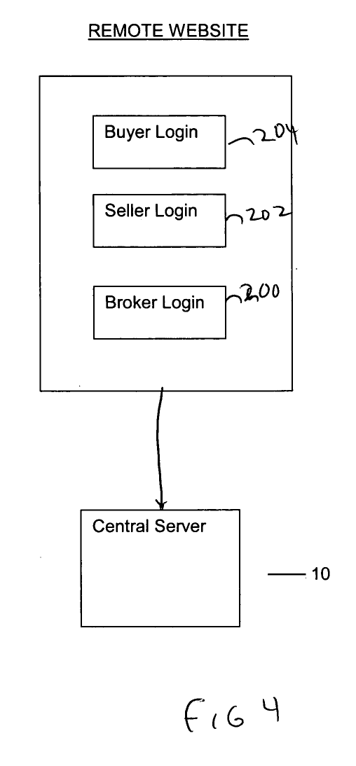

The present invention is now described with reference to FIGS. 4 through 8. The system is described in the context of a system in which a broker, seller and buyer can log in areas 200, 202, 204. The system links to central server 10. The invention is specifically directed to a system for facilitating the sale and brokering of HVPs. As shown in FIG. 4, the system is designed and configured so that the broker can store and upload data and listings 304 locally or on the central server. Through the Digital Methods Suite, the broker thus has total control over which listings will be maintained locally and which will be provided to a wider network of selected brokers 306 or all brokers 308.

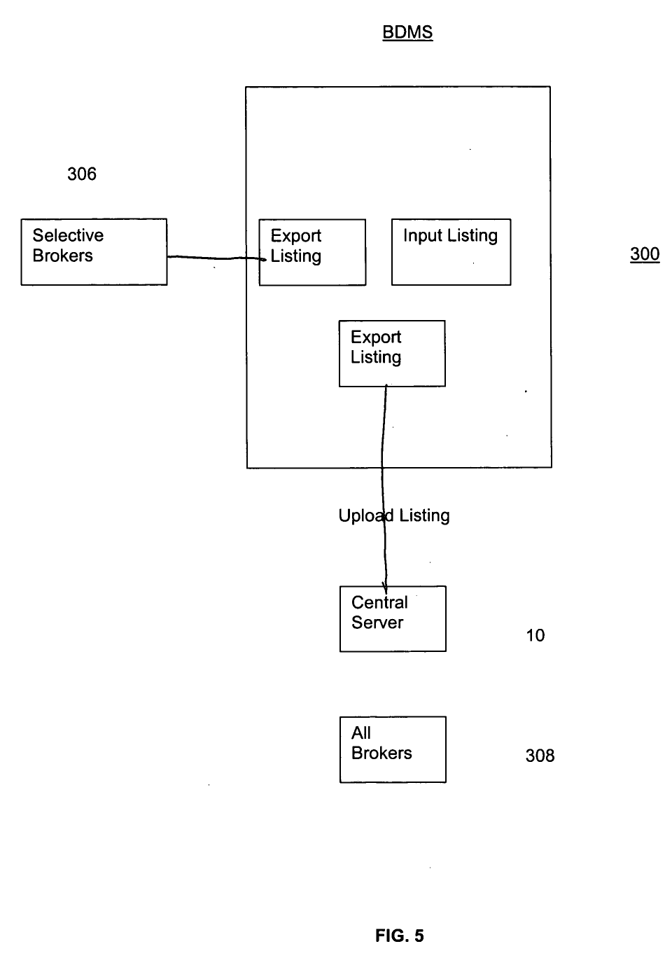

Referring to FIG. 5, a critical feature of the invention is the Brokers' Digital Methods Suite (BDMS) 300. This is an interface that will reside on the brokers' computer and directly exchanges selected data from BDMS's via the Internet to data contained in advertising databases of various cooperating publications, and links to publications whose web sites are enabled to accept ads via standard browsers. In short, the BDMS provides a number of applications which are stored locally and which are usable in the brokers' businesses.

The BDMS system thus communicates data between the brokers' BDMSs via the Internet and publishes HVP listing information in digital code that communicates with other web browsers. Brokers may use the BDMS system to publish uniform listing options to the WEB for lookup and viewing by the general public. The central server offers queries for the public to view any HVPs currently published on the central system that meet their criteria and/or create a Request of their own specifications.

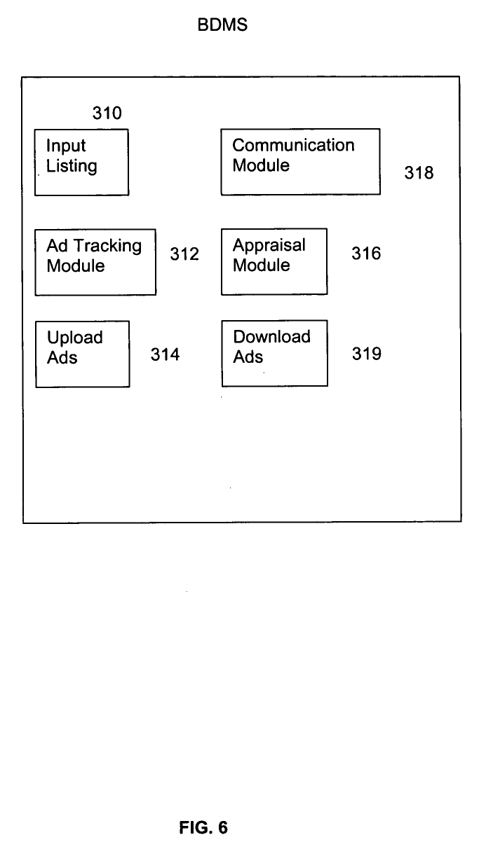

Referring to FIG. 6, the BDMS 300 has a number of modules, including EULF 310 and tracking module 312 to upload ads 314, appraisal module 316, communication module 318, and download module 318. The BDMS can transmit printed uniform listings to prospective buyers via postal mail or e-mail (where links to the BDMS server or the broker's own web server can also display the uniform listing(s) electronically, or a buyer can request a phone call from the broker(s) with HVP that matches the buyer's request specifications. In addition to receiving uniform listings from the broker(s) BDMSs in connection with HVPs that are currently available for sale in the brokers' BDMSs, as HVPs being “tracked” in the broker's BDMS systems become for sale over time, the prospective buyer(s) receive new uniform listings. They also receive updates of current uniform listings, e.g., status changes such as price or location, under contract, sold, etc, from the brokers' BDMS systems.

In addition, the BDMS Sever enables the owner of an HVP to provide specific information about a particular HPV (s)he, for example, owns and is considering selling, enabling the prospective seller to order the information to be transmitted (to one or many) broker(s). The owner of the HVP transmits this information, if, for example, he wishes to receive an opinion of the approximate market value of the HVP from one or more brokers. The seller may wish to be contacted by brokers whose BDMS systems have a potential buyer(s) in their BDMS database files, when said buyers specifications (requests) are similar match to the specifications of the HVP the prospective seller is interested in selling.

The owner may wish to “list” the HVP for sale with one or more brokers of his/her choice. He may choose the broker(s) to which the details of the HVP are transmitted. The BDMS Web Site can send the information to all the HVP subscriber brokers that handle the appropriate type of HVP, or, if the seller prefers, forward it to brokers who handle HPVs of the type similar in classification and/or other aspects to the HVP being transmitted. The seller may select a particular broker(s) to whom the information will be transmitted or link directly, communicating directly to BDMS equipped brokers with their own Web Sites.

The BDMS thus comprises a local data management system specifically built for brokers of HVPs, to store data on computers or networks which are operated and controlled by brokers, including data the broker publicizes and data not ready for publication. The BDMS systems may be delivered to a broker's computer on line or on disk before data entry begins or with certain data already included. Each broker (e.g., “subscriber”) uses BDMS to store and work with his/her own data. As noted, a copy of BDMS normally will be located at the broker's site on the broker's own computer or LAN.

Alternatively, it could be stored at the central server 10, still accessible only to the broker (or those to whom (s)he authorizes access), e.g., connected via a WAN or VPN. Each broker's BDMS is capable of including data entered by the broker and/or data received electronically by the broker from another computer (e.g., the broker purchases data from the “ad database” of a publication that advertises HVPs for sale of the type handled by the broker) or, alternatively, the data is purchased at the central server and then provided to the brokers for a fee.

In summary, at the discretion of a broker who is a “subscriber” or otherwise licensed to use a copy of the invention's BDMS, his/her data may be shared automatically, or manually in as little or as much detail the broker wishes, e.g.:

a. Not shared with anyone by the BDMS without specific instructions (commands) issued by the broker to share data with selected recipients;

b. Forward to specific entities by the BDMS (e.g., clients of the broker or the clients' representatives), by Postal mail or email as a result of automatic (or manual, if ordered) BDMS methods engaged (commands issued by the broker at his computer).

c. Transmit ads of HVPS for sale to publication(s) selected by the broker(s). Electronic protocols shared by the BDMS and the publication(s) enable the broker(s) to place, review, approve and be billed using BDMS commands. The central server could purchase the ad date.

The BDMS permits the broker to instantly publish (or unpublish) selected uniform listing(s) to the central server, thus eliminating the need to log into a web listing service via a web browser and creating the listing in the web service's format (e.g., re-typing an entire listing to suit the format used by a particular listing service). In one aspect of the invention, the BDMS the web browser recognizes the uniform listing format received from the broker's BDMS and publishes listings to the World Wide Web to be displayed in the uniform listing format.

The record and update the existence of specific HVPs into the broker's BDMS, (usually the BDMS data is maintained “off line” on the computer or the LAN of a Dealer/broker). The collect/record information in connection with persons while (or prior to) creating BDMS records for them. The collect/record info in connection with companies, while (or prior to) creating BDMS records for them.

The BDMS will identify companies recorded in the database while (or subsequent to) creating records for the persons. Automatically build an Employment History file on Persons as the operator records changes of employers (companies) of BDMS persons.

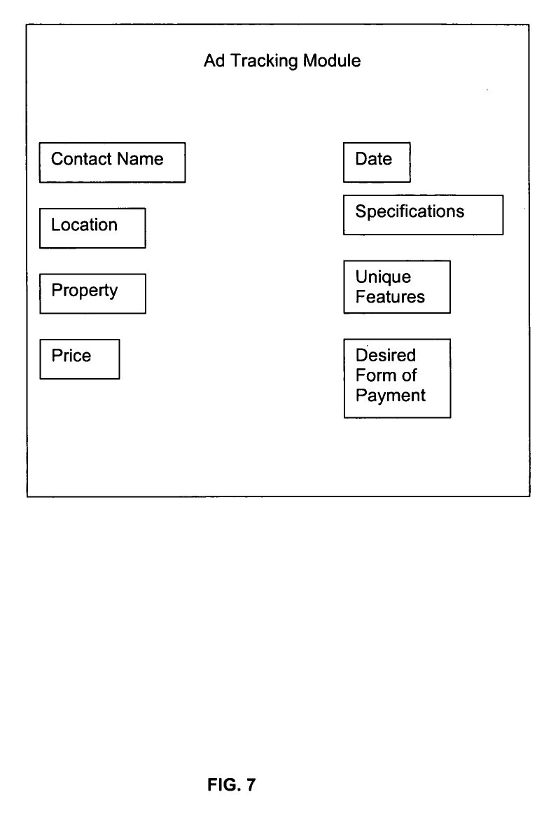

A critical feature of the present invention as a component of the BDMS's is the inclusion of an ad tracking module 312. As shown in FIG. 7, this module continually monitors advertising of HVPs by the sellers (owners and/other brokers & companies or other representatives of the owners), updating records of the advertised HVPs including the dates of the ad 330, prices asked (including flagging price reductions) 332, source(s) of the information, “contact” parties, seller's desire to accept non-cash assets as partial (or full) payment 334, adding previously unknown (or correcting previously incorrect) equipment and features included with the HVPs, and claims of their condition and additional information and comments. The BDMS system will help the broker find new properties (e.g., the publication ad tracking system described above).

The ad tracking system collects and records detailed information via “live” (usually as a result of direct conversations with) owners or their brokers, other representatives or persons with knowledge of a particular HVP and record it into the BDMS database as the information becomes available. Programmatically record updates to the status of the HVPs, automatically updating the status of the offering (Listing), and record at least the following information, (as is available):

1. Is the HVP for sale at the time? Are any offers outstanding or any deals pending?

2. If for sale, at what asking price?

3. If for sale, an indication of the lowest acceptable selling price.

4. If for sale, who to contact to gain access to the HVP (or instructions for showing it to prospective purchasers.

5. The location of the HVP.

6. The latest “listing” details including upgrades or other changes made to the HVP or its condition since its last “update”.

7. If for sale, an indication whether the Owner is willing to take any non-cash asset(s) as partial or full payment for the HVP.

8. Information as to whether the Seller of the HVP is interested in purchasing another HVP.

9. Does the broker have a contractual “listing agreement” with the Seller of the HVP? If so, what are the relevant details?

The BDMS programmatically transmits (via postal or email), communications to BDMS entities (e.g., a person or company) with HVP(s) for sale, said communications requesting updates on the status of their offerings. The BDMS records replies as information updates are received, thereby updating the status of the HVP offering(s) with minimal human intervention.

The BDMS generates a log of every “live” (conversation) contact between the broker and any person on record in the BDMS, including comments of the discussion. Add “requests” (specifications of HVP(s) desired for purchase) to the records of persons interested in receiving information of HVPs for sale with the ability to identify the buyer and, where applicable, the buyer's broker.

The system can transmit (via postal mail, email, or email links), the ability to view (and print if transmission is digital) listings of HVPs for sale to BDMS Persons (and/or their brokers) who have REQUESTS on file. This transmission first takes place when a person's specifications are entered into the BDMS as a request, then subsequently recurs, transmitting listings of HVPs that become available on the market over time that match each request the person(s), or their broker(s), have filed to the BDMS. Previously transmitted listings' status changes (e.g., the price reductions), may also be transmitted to persons whose requests match the specifications of those listings.

Automatically the system can build an historical file of “HVPs previously owned” history file for persons as the BDMS operator records sales and purchases of HVPs by persons.

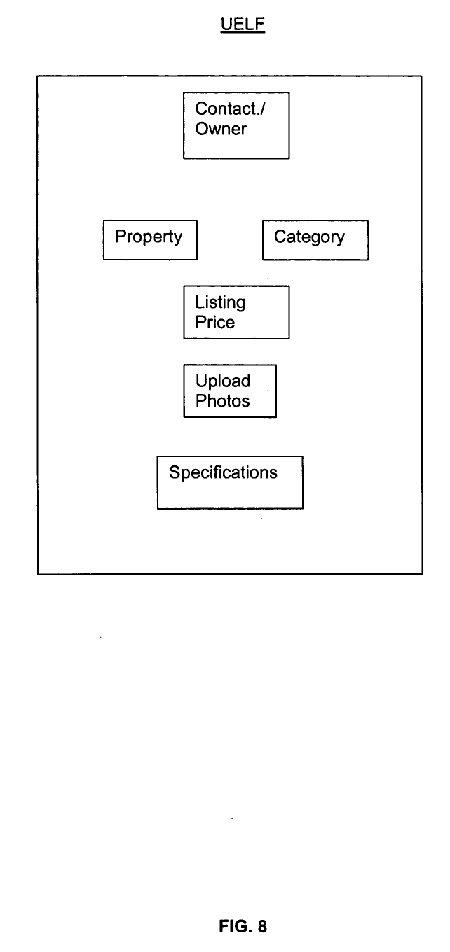

Referring to FIG. 8, a critical aspect of the invention is the inclusion of a method for instantly transmitting (or withdrawing) a detailed uniform listing of each HVP selected from the BDMS to the Central Server (brokers who acquire the right to use the invention also acquire this ability via a simple BDMS command performed on their own computers or computer networks). The details needed by prospective purchasers (or their representatives) of each HVP that are transmitted reside on the broker's BDMS, so no additional work is required to list HVP(s) for sale on the BDMS server (this exceeds and substantially improves capabilities currently available on the Internet, while other details (e.g., the identity of the HVP's ownership) are not transmitted and are accessible only to the party(s) who have access to the broker's BDMS. With a secure firewall installation those details are inaccessible to the Internet (hackers, etc).

Unlike the Broker's BDMS “private” data, details published to the BDMS server may be accessible to anyone with a web browser. A simple “point and click” transmission method that enables a broker to automatically (and instantly) transmit uniform listing details of selected HVPs for sale from his BDMS “private” data to the BDMS Web Site presents a new method of “listing” select-ed HVP's on line that saves the user of the BDMS (dealers & brokers) and the viewers of the published information substantial time and presents them with several distinct and important conveniences and new advantages:

The EULF will reside on the machine of the broker. Unlike the customary methods currently used by brokers for collecting data to generate listings, with BDMS, data pertaining to specific features of each HVP is recorded using a ‘point and click’ method to fill out an “electronic listing form”.

The basic template of the EULF is adaptable to all types and categories of HVPs. The EULF template is formatted in such a way that after adapting it to a specific type or category of HVP, the form itself may be deemed a copyrighted work. There are 2 variations of each EULF envisioned by the inventor, the data “input” version and the data “display” version. For example, a typical input version contains a main header, and tabs representing a number of categories.

Each tab may be labeled with its category alphabetically sorted (e.g., from left to right, appearing across the top of the form). By “clicking on” a tab during the information inputting procedure the category it represents is displayed on the page with an alphabetically sorted list of the kinds of features and equipment that fall under that category.

There will be a checkbox next to each item. When the operator “clicks on” one of the checkboxes, the cursor automatically jumps to the text line for the selected item (directly next to the checkbox selected), enabling the operator to type additional descriptive information about the item.

Data may be entered all at once or as it becomes available. The user may locate and tag any item on the form with a maximum of two mouse clicks (the category tab, then the specific item checkbox). The data entered about an HVP is automatically stored in the BDMS, and may be viewed anytime by opening the “display version” of the EULF. This process produces a separate printable listing for prospective buyers to view that categorizes and alphabetically sorts every item or feature that a broker, skilled in the market for a certain category of HVP would normally expect to find as a standard, optional or custom installed on the type of HVP s(he) lists. The display version of the EULF can also be printed (on paper) in “blank”, may be filled in manually, then subsequently entered electronically into the broker's BDMS by using the input version.

The printable (display) “listing form” serves several purposes and creates conveniences, advantages and time savings for the seller, the dealer or broker, and the prospective buyers of HVPs that have never been available together in a single package in the past. such as, for example:

The categories of data for a particular type of HVP and the kinds of data included in each category are predetermined and alphabetized, which saves time, adds convenience and accuracy for data entry persons, sellers, brokers and prospective buyers of HVPs in at least the following manners:

In the case of brokers, the information will be input by a data entry person is automatically prompted to “know”, without special training, which data to consider (ask) for inclusion in each specific category, not overlooking questions that should be asked during the process of “obtaining the listing”.

A data entry person is able to easily locate any item the seller brings into the conversation voluntarily, click on the item, and add information the seller gives in connection with the item. This inspires a much more conversational mode than a “question/answer” session method of getting the listing.

The “display” version (the listing to be published) can be modified without opening the “Input” version of the EULF.

a. When buyers, brokers and sellers review an EULF uniform listing, it is easy to know where to locate any specific item or feature of the HVP (e.g., a piano) because the EULF listing data entry form (and the data printout) forms become familiar “naturally” to any person who is familiar with the alphabet.

b. It is easy to compare numerous HVPs of like kind that are for sale, item for item, when they are all listed on the listing form, whether printed or electronically displayed.

c. Inaccuracies due to misunderstood words and misspellings are minimized with the listing form.

Many types of HVP exists virtually “everywhere.” It also shows that many publications exist that specialize in reporting about specific HVP, and that many of these publications advertise new and used HVP for sale. There are also general publications that advertise HVP for sale (e.g., the “classifieds” in a local or major newspaper).

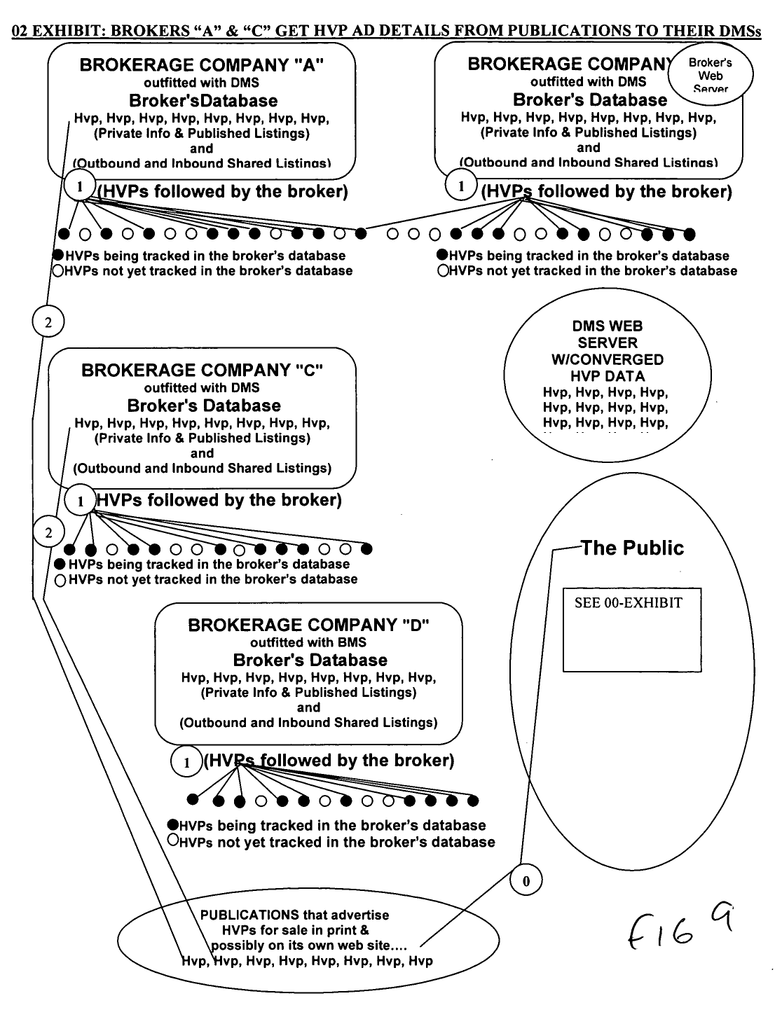

Referring to FIGS. 9 to 14, specific examples of the operation of the present invention are now described. Each broker (or brokerage company) recognizes the fact that HVPs exist, whether they are for sale or not, and tracks as many of these as they can (Identified by the black circles). The white circles represent HVPs the broker is not aware of specifically, (but he knows there are “always” HVPs he is not aware of).

As shown in FIG. 9, Brokerage “A” and Brokerage “C” both purchase information from publications that advertise “HVPs” for sale, and can manually copy or download the data on advertised HVPs into their own Broker Digital Management Systems (BDMS).

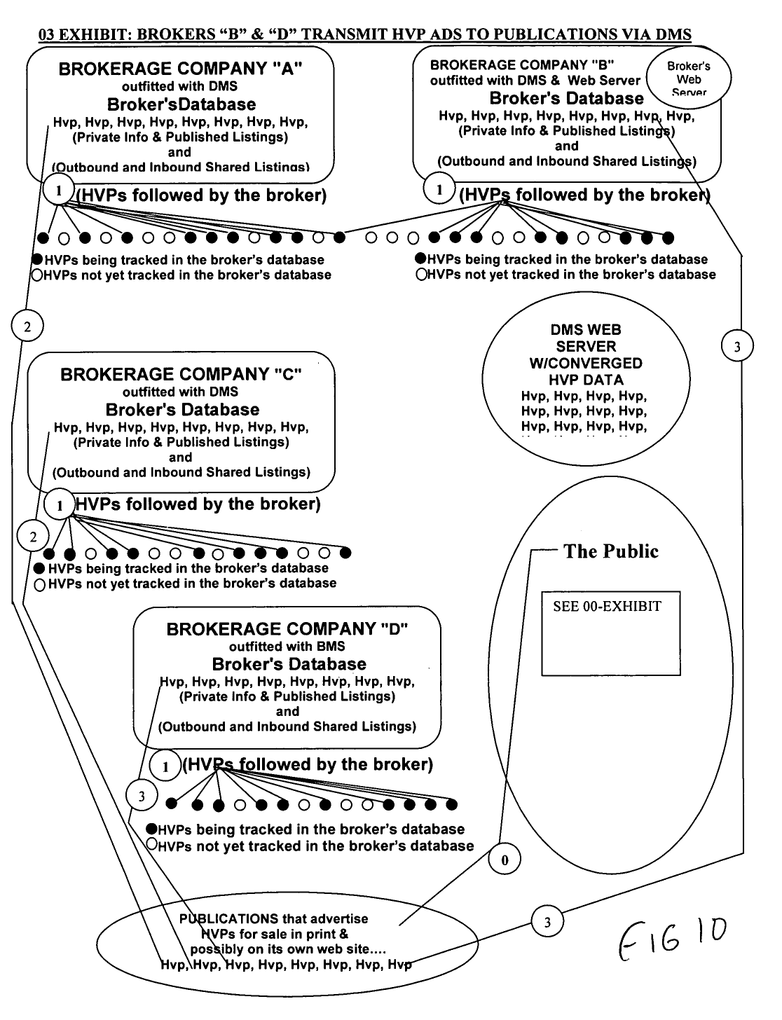

Referring to FIG. 10, Brokerage “B” and Brokerage “D” both transmit ads to publications that advertise “HVPs” for sale, providing the data on the HVPs they wish to advertise to the Publications' they wish to advertise in. The entire process is conducted directly from the brokers' own computer systems using their BDMS.

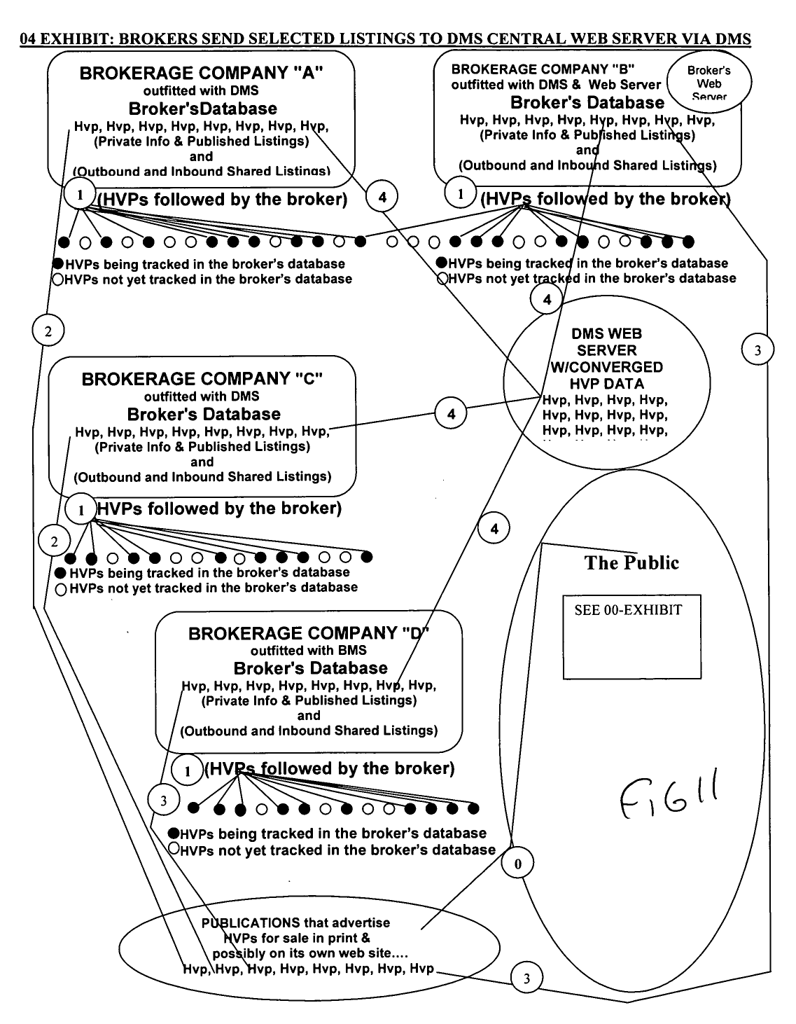

As shown in FIG. 11, Brokerages A, B, C, & D use their BDMS systems to transmit listings of HVPs for sale to a Computer which serves the listings to the general public via the Internet (“The Central Server”). They also receive some of their specifications from prospective purchasers of HVPs via this bi-directional channel (4).

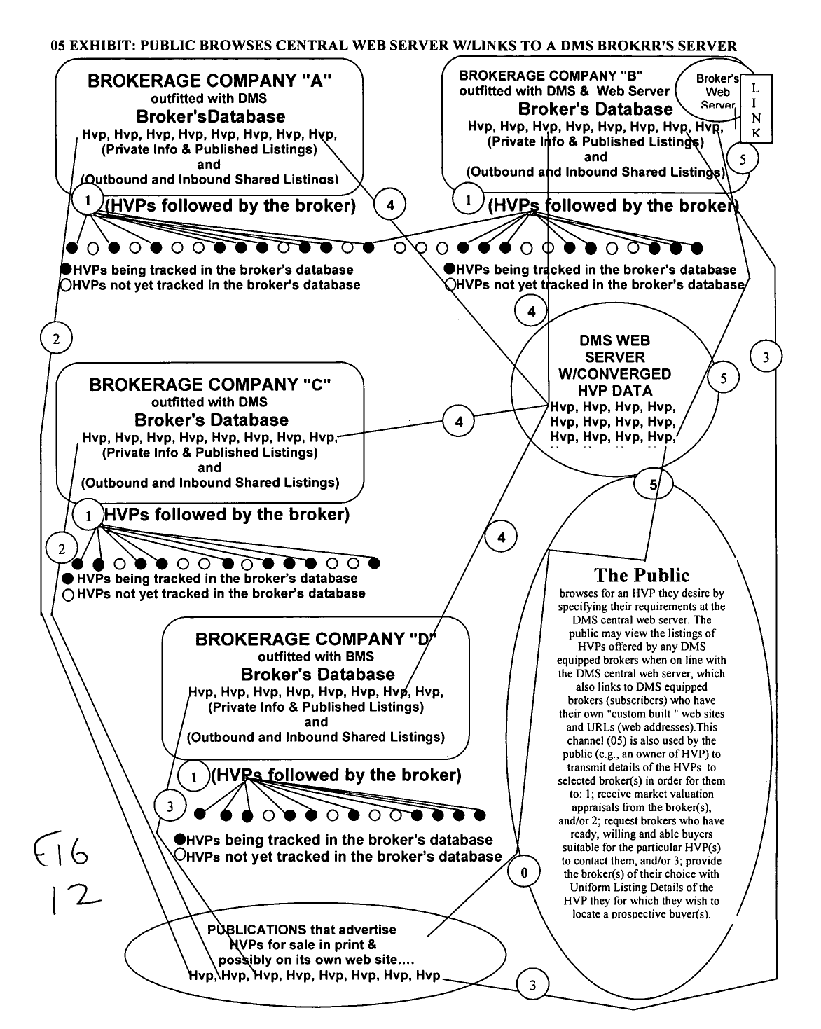

As shown in FIG. 12, the public may browse or search for an HVP they desire by specifying their requirements at the BDMS central web server. The public may view the listings of HVPs offered by any BDMS equipped brokers when on line with the BDMS Web Site, which also contains “links” to BDMS equipped brokers (subscribers) who also have their own “custom built” web sites (e.g., Broker “B”) and URLs (web addresses). This bidirectional channel (05) is also used by the public (e.g., an owner of HVP) to transmit details of the HVP(s) to selected broker(s) in order for the public to: 1; receive back market valuation appraisals from the broker(s), and/or 2; request brokers who have ready, willing and able buyers suitable for the particular HVP(s) to contact them, and/or 3; provide the broker(s) of their choice with the Uniform Listing Details of the HVP they wish to locate.

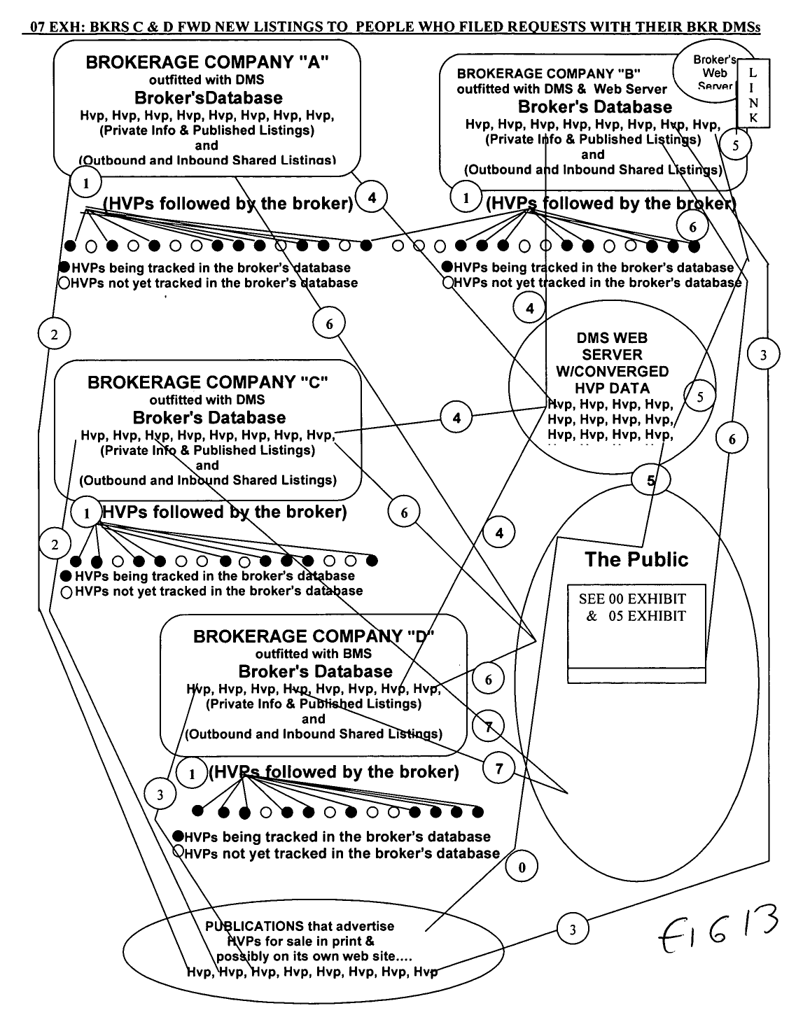

As shown in FIG. 13, at the option of the prospective buyers, their specifications are supplied to BDMS brokers either via the BDMS server (which transmits the request to each BDMS broker as specified (via channel (4), links the buyer directly to Broker B's server (via channel 5, a bi-directional channel), or the buyer directly contacts any brokers he wants in any method he wishes, via channel (6) (e.g., calling the broker by telephone or writing the broker a letter, or by the Internet or via facsimile). It is anticipated that brokers may be provided a private spam free email account with which to conduct additional communication operations. Brokers will have the selective ability to designate the breadth of their communications with other brokers and/or other users of the system.

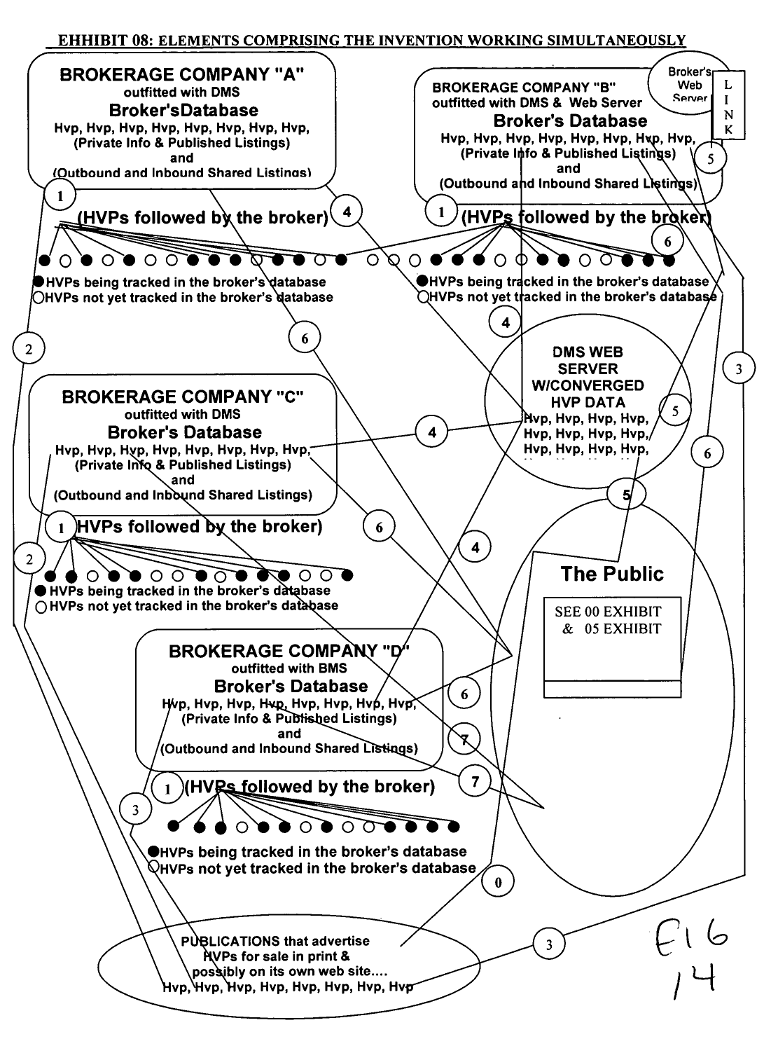

Referring to FIG. 14, as HVPs become listed with a BDMS equipped broker, the broker's HVP forwards a listing directly to the suitable (prospective purchasers whose specifications match the HVP(s) that have become listed) using the method requested by the prospective purchaser (e.g., postal mail, email, or telephone). In the diagram, the BDMS systems of Brokers “C” and “D” located HVPs matching those specified by certain buyers, and the brokers forwarded listing details to the buyers who had made the requests.

The elements comprising the invention working simultaneously so as to keep the market moving as a result of the invention working in operation with multiple buyers, sellers and brokers all participating, and utilizing methods provided by the invention that meet each of their respective needs.

The present invention has been described with reference to the enclosed Figures and detailed description. It is to be appreciated that the true nature and scope of the present invention is to be determined.

1. An apparatus for managing the purchase and sale by a broker of a high value piece of property comprising:
a control unit for inputting information by a broker related to a high value property item and for posting information about the property; and
publishing the information to at least one buyer.

2. The apparatus of claim 1 further comprising means for downloading advertising related to identity of other high value properties.

3. An apparatus for managing the transaction between a broker and a seller of a high value property comprising:
program means for identifying a plurality of high value properties and their sellers;
a control unit for inputting listing information about at least one high value property to be sold and determining whether the high value property is to be placed for sale on within a larger network of brokers;
means for assisting the at least one seller in formulating an asking price for the at least one high value property; and
means for publishing the listing to third parties at the asking price.

4. The apparatus of claim 3 further comprising means for uploading ads relating to a plurality of high value properties which may be listed onto the apparatus.

5. A method for managing the relationship between a broker and a seller of a high value property comprising:
identifying a plurality of high value property for sale and their sellers;
inputting listing information about at least one high value property to be sold;
determining whether the high value property is to be placed for sale on within a larger network of brokers;
assisting the prospective seller in formulating an asking price for the high value property; and
publishing the listing to at least one third party.

6. The method of claim 5 further comprising the step of uploading an advertisement related to the listing.
